(19) United States
(12) Patent Application Publication
(10) Pub. No.: US 2026/0316992 A1
(43) Pub. Date: Oct. 15, 2026

(54) PACKAGING BOX FOR FISHING REEL

(71) Applicant: DOYO ENGINEERING CO., LTD., Bucheon-city (KR)

(72) Inventor: Kang Ho HYUN, Bucheon-si (KR)

(21) Appl. No.: 19/645,096

(22) Filed: Apr. 10, 2026

(30) Foreign Application Priority Data
Apr. 15, 2025 (KR) 10-2025-0048591

(51) Int. Cl. B65D 5/50; B65D 5/02

(52) U.S. Cl. CPC B65D 5/5016; B65D 5/0254

(57) ABSTRACT

Provided is a packaging box for a fishing reel, which stores the fishing reel shipped as a product, so as not to allow it to move within the box, thereby preventing damage to the product due to impact during storage and delivery, and specifically, includes a first fixing member configured to be in close contact with the upper portion of the fishing reel when a reel seat is arranged downward, or a second fixing member configured to be in close contact with the lower portion of the fishing reel, or both the first and second fixing members, wherein the first fixing member is a partition wall portion having a fitting groove into which a stud of the fishing reel is fitted and the second fixing member is composed of a base portion protruding at a predetermined height from a bottom portion to support a frame.

### CROSS REFERENCE TO RELATED APPLICATION

### BACKGROUND OF THE INVENTION

### Field of the Invention

The present disclosure relates to a packaging box for a fishing reel and, more particularly, to a packaging box for a fishing reel, which stores the fishing reel shipped as a product, so as not to allow it to move within the box, thereby preventing damage to the product due to impact during storage and delivery, and specifically, includes a first fixing member configured to be in close contact with the upper portion of the fishing reel when a reel seat is arranged downward, or a second fixing member configured to be in close contact with the lower portion of the fishing reel, or both the first and second fixing members, wherein the first fixing member is a partition wall portion having a fitting groove into which a stud of the fishing reel is fitted and the second fixing member is composed of a base portion protruding at a predetermined height from a bottom portion to support a frame, thereby even supporting the reel seat or a gearbox and fundamentally blocking the movement of the fishing reel.

### Description of the Related Art

A fishing reel, particularly a baitcasting fishing reel, is provided with a gear assembly in which gear bundles are built into one side of a frame on which a spool is mounted, and has a structure in which a handle is coupled through a stud coupled to the gear assembly.

It is common for such a baitcasting fishing reel to be packaged in a box for shipment.

However, since the handle is rotatable and typically longer in its front-to-rear length than that of the frame, and the thickness in the vertical direction of the gear assembly is greater than that of the frame, the handle becomes unbalanced left and right relative to the gear assembly, causing it to tilt to one side rather than sitting straight.

Accordingly, when the baitcasting reel is packaged inside the typical box, the entire product should be wrapped with packaging materials such as bubble wrap to protect the product. However, due to such a structure of the fishing reel described above, it is difficult to package it evenly with the packaging materials, and there were problems such as waste generation and increased packaging costs due to the use of packaging materials.

### SUMMARY OF THE INVENTION

Accordingly, the exemplary embodiments of the present disclosure have been devised to solve the problems described above, and an objective of the present disclosure is to provide a packaging box for a fishing reel, which is configured to prevent damage to the product, reduce manufacturing costs, and improve productivity by allowing the fishing reel to be stably stored and packaged in a fixed state within the box.

In order to achieve the above objective according to the present disclosure, there is provided a packaging box for a fishing reel provided with a handle, a stud surrounding a shaft connected to the handle, and a frame having a spool mounted thereon, a gearbox provided on a stud side thereof, and a lower reel seat, the packaging box including: a bottom portion and sidewall portions in a hexahedral form constituting a storage portion for the fishing reel; and a cover for opening and closing a top opening of the packaging box, wherein the packaging box includes a first fixing member configured to be in close contact with an upper portion of the fishing reel when the reel seat is arranged downward, or a second fixing member configured to be in close contact with a lower portion of the fishing reel, or both the first and second fixing members.

In addition, in the packaging box for the fishing reel according to the present disclosure, the first fixing member may include a partition wall portion provided with a fitting groove into which the stud is fitted.

In addition, in the packaging box for the fishing reel according to the present disclosure, the packaging box may further include a base portion protruding at a predetermined height from the bottom portion and configured to support the frame.

In addition, in the packaging box for the fishing reel according to the present disclosure, the base portion may include a first base portion configured to support the reel seat of the frame.

Further, in the packaging box for the fishing reel according to the present disclosure, the base portion may include a second base portion configured to support the frame.

According to the present disclosure, the packaging box for the fishing reel has an effect where the fishing reel is stably stored with left and right balance by the base portion that supports the bottom surface of the frame when the stud between the frame and the handle is inserted into and fixed to the fitting groove of the partition wall portion, so as to fundamentally prevent movement of the fishing reel, thereby preventing the product from being damaged during storage and delivery.

### BRIEF DESCRIPTION OF THE DRAWINGS

FIGS. 1A and 1B are views illustrating a configuration of a fishing reel.

FIGS. 2 and 3 are perspective views illustrating a first exemplary embodiment according to the present disclosure.

FIG. 4 is an unfolded view illustrating the first exemplary embodiment according to the present disclosure.

FIG. 5 is a schematic plan view illustrating the first exemplary embodiment according to the present disclosure.

FIG. 6 is a schematic rear view illustrating the first exemplary embodiment according to the present disclosure.

FIG. 7 is a perspective view illustrating a second exemplary embodiment according to the present disclosure.

FIG. 8 is an unfolded view illustrating the second exemplary embodiment according to the present disclosure.

FIG. 9 is a schematic plan view illustrating the second exemplary embodiment according to the present disclosure.

FIG. 10 is a schematic rear view illustrating the second exemplary embodiment according to the present disclosure.

FIGS. 11A and 11B are cross-sectional views illustrating a modified example of the first exemplary embodiment according to the present disclosure.

### DETAILED DESCRIPTION OF THE INVENTION

The present disclosure may, however, be embodied in many different forms and have various forms, and implementation examples (i.e., aspects or exemplary embodiments) will be described in detail in the specification. However, this is not intended to limit the present disclosure to a particular disclosed form. On the contrary, the present disclosure is to be understood to include all various alternatives, equivalents, and substitutes that may be included within the idea and technical scope of the present disclosure.

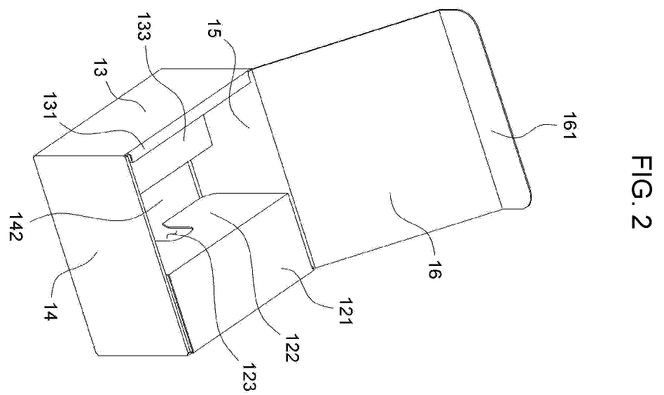

In describing a packaging box for a fishing reel according to the present disclosure, for convenience, when an approximate rough direction standard is specified with reference to FIG. 2, a direction in which gravity acts is set as a lower side, and a visible direction, as it is, is set as each of the up, down, left, and right directions. In addition, in the detailed description and claims of the present embodiments related to the other drawings as well, unless otherwise specified, directions are specified and described in accordance with this standard.

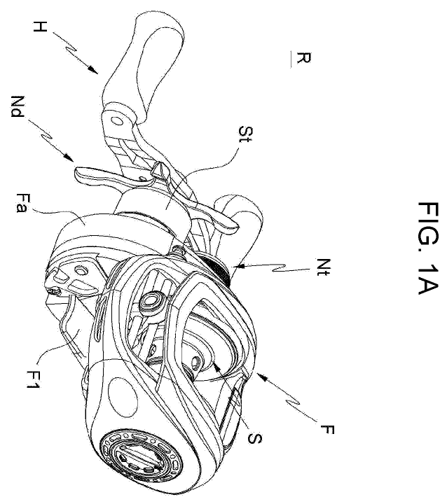

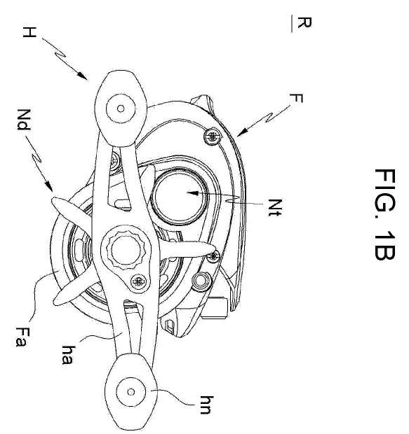

Before describing, a structure of the fishing reel, particularly the baitcasting fishing reel R, is described in detail with reference to FIGS. 1A and 1B below. The fishing reel includes: a handle H; a stud St configured to surround a shaft connected to the handle H; and a frame F having a spool S mounted thereon, a gearbox Fa provided on a stud St side thereof, and a lower reel seat F1.

In addition, on a side cover of the gearbox Fa, a tension nut Nt is configured to protrude separately from the stud St, and a star drag nut Nd is coupled between a handle arm Ha and the stud St.

In addition, typically, the gearbox Fa has a shape roughly like a teardrop and has a structure protruding downward from the reel seat F1 of the frame F.

Hereinafter, the packaging box for the fishing reel according to the present disclosure will be described on the basis of the baitcasting fishing reel R having the above-described structure with reference to the attached drawings.

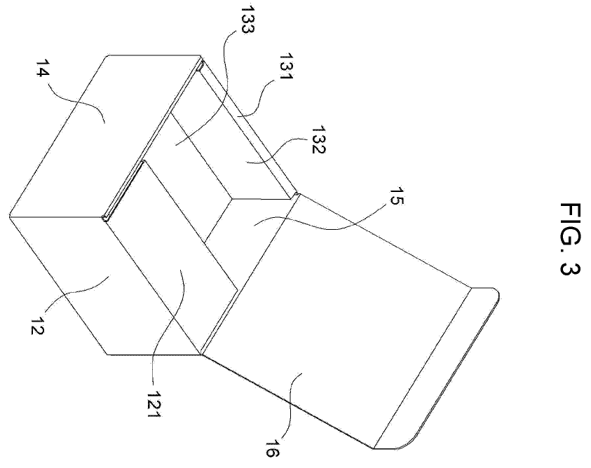

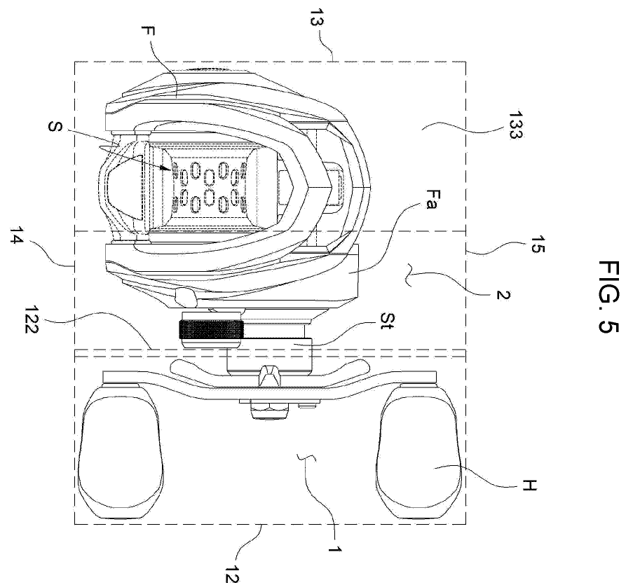

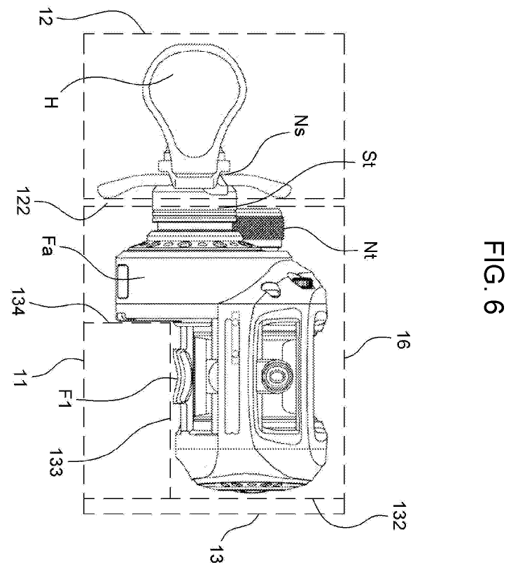

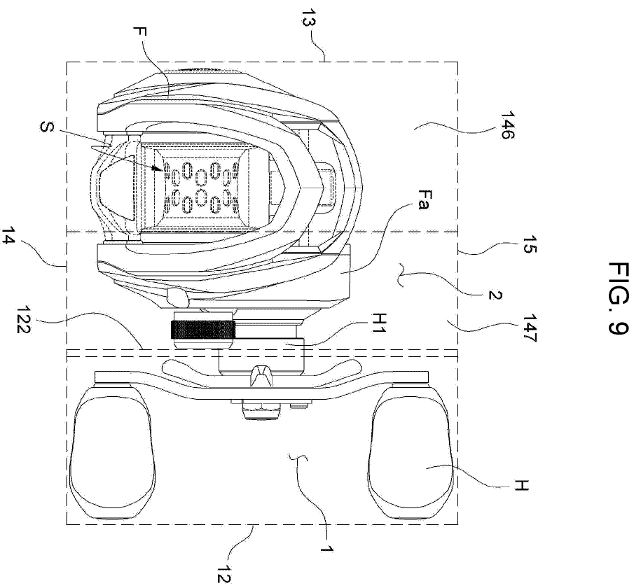

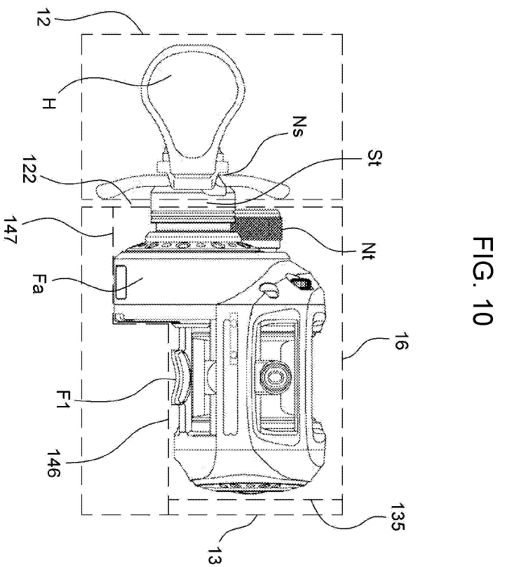

As illustrated in FIGS. 2 to 10, the present disclosure relates to the packaging box for the fishing reel having the above-described structure, and the packaging box is provided with a hexahedral bottom portion 11 and sidewall portions 12, 13, 14, and 15, which are constituting a storage portion for the fishing reel, and has a general box-shaped exterior connected with a cover 16 for opening and closing a top opening of the packaging box.

In addition, the exemplary embodiments of the present disclosure include a first fixing member configured to be in close contact with the upper portion of the fishing reel when the reel seat F1 is arranged downward, or a second fixing member configured to be in close contact with the lower portion of the fishing reel, or both the first and second fixing members.

Specifically, in the present disclosure, the first fixing member is composed of a partition wall portion 122 provided with a fitting groove 123 into which the stud St is fitted when the reel seat F1 is arranged downward.

The second fixing member includes a base portion Sp protruding at a predetermined height from the bottom portion 11 to support the frame F.

The first exemplary embodiment of the present disclosure includes: a partition wall portion 122 provided with a fitting groove 123 into which the stud St between the frame F and the handle H is fitted, the partition wall portion 122 forming a handle storage portion 1 together with a first side surface sidewall portion 12; a first base portion 133 spaced upward from the bottom portion 11 to support the reel seat F1 of the frame F; a connecting portion 121 in which the upper end of the partition wall portion 122 and the upper end of the first side surface sidewall portion 12 are connected to each other, so as to cover the handle storage portion 1; a first inner wall portion 132 bent downward inward from the upper end of a second side surface sidewall portion 13 (opposite to the first side surface sidewall portion 12) and connected to an outer end of the first base portion 133; and a support portion 134 bent downward from the inner end of the first base portion 133 and supported on the bottom portion 11, wherein a storage groove 2 allowing the gearbox Fa of the frame F to be placed therein is formed between the partition wall portion 122 and the support portion 134.

In the drawing, one representative exemplary embodiment is shown in which bottom wing portions 111 connected to respective lower ends of the sidewall portions 12, 13, 14, and 15 are folded and assembled in a press-fit manner to constitute the bottom portion 11, but the structure forming the bottom portion 11 may be modified into various known box shapes.

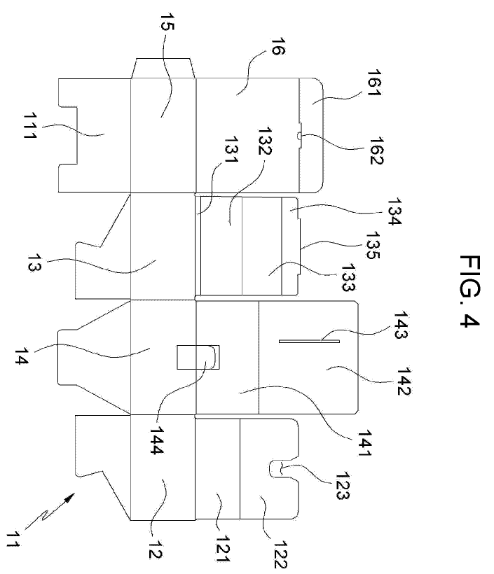

Referring to the unfolded view of FIG. 4, the respective sidewall portions 12, 13, 14, and 15 are connected to the ends corresponding to the four sides of the bottom portion 11, and the respective sidewall portions 12, 13, 14, and 15 are foldably connected to the other adjacent sidewall portions 12, 13, 14, and 15 one another, so that the first side surface sidewall portion 12 and the rear sidewall portion 15, which are positioned at left and right ends based on this unfolded view may be folded into a hexahedral shape through an adhesive portion so as to be assembled together.

In addition, the connecting portion 121 is foldably connected to the upper end of the first side surface sidewall portion 12, the partition wall portion 122 is foldably connected to the upper end of the connecting portion 121, and the fitting groove 123 is cut in a shape similar to “U” in the partition wall portion 122.

In addition, a folding portion 131 is foldably connected to the upper end of the second side surface sidewall portion 13, a first inner wall portion 132 is foldably connected to the upper end of the folding portion 131, a first base portion 133 is foldably connected to the upper end of the first inner wall portion 132, a support portion 134 is foldably connected to the upper end of the first base portion 133, and an assembly projection 134a is configured to protrude from the upper end (or the lower end in a folded state) of the support portion 134.

In this case, the folding portion 131 may be omitted.

It is preferable that the assembly projection 134a be formed in the shape of a bar having a predetermined length or more so as to prevent deformation of the support portion 134 when the assembly projection 134a is fitted into the assembly groove 143 to be described later.

In addition, a second inner wall portion 141 is foldably connected to the upper end of the front sidewall portion 14, an inner base 142 is foldably connected to the upper end of the second inner wall portion 141, and the inner support 142 has an assembly groove 143 that is cut so as to allow the assembly projection 134a to be inserted.

The inner base 142 has a form corresponding to the shape and size of the entire bottom portion 11, thereby protecting the bottom of the packaging box in a double layer as the support portion 134 is assembled.

The reference numeral 144 in the drawing is a locking portion configured to prevent the cover from opening when the cover is closed, and the locking portion 144 may be omitted.

In addition, the cover 16 is foldably connected to the upper end of the rear sidewall portion 15, an insertion portion 161 is foldably connected to the upper end of the cover 16, and a locking groove 162 allowing the locking portion 144 to be fittable is formed in an edge portion where the rear sidewall portion 15 and the cover 16 are connected to each other.

The respective components connected to the front sidewall portion 14 and the rear sidewall portion 15 may be configured in opposite ways.

In such a first exemplary embodiment, in a state in which the sidewall portions 12, 13, 14, and 15 are folded into a hexahedral shape and attached and then the bottom portion 11 is assembled, the second inner wall portion 141 is bent downward toward an inner side of the front sidewall portion 14, and the inner base 142 is bent to be flat in a horizontal state.

In this state, the folding portion 131 is bent inward in the horizontal direction, the first inner wall portion 132 is bent inward in the vertical direction, and the first base portion 133 is bent inward in the horizontal direction. Thereafter, when the support portion 134 is bent downward, and the assembly protrusion 134a is fitted into the assembly groove 143, the first base portion 133 is spaced upward from the bottom portion 11 by a predetermined distance. At this time, the height of the first base portion 133, that is, a vertical width of the support portion 134, is formed to correspond to a height difference from the bottom surface of the reel seat F1 to the lower end of the gearbox Fa.

In this assembled state, in a state in which the stud St, more precisely, a portion of the stud St between the tension nut Nt and the star drag nut Nd, is fitted into the fitting groove 123, the connecting portion 121 is bent inward in a horizontal direction, and then the partition wall portion 122 is bent upward to stand upright. When the bottom surface of the frame F, more precisely, the bottom surface of the reel seat F1 is placed on the first base portion 133, the storage of the fishing reel is completed.

In the present disclosure, the gearbox Fa is safely stored in the storage groove 2 between the first base portion 133 and the partition wall portion 122, and a handle storage portion 1 covered by the connecting portion 121 is formed between the first side surface sidewall portion 12 and the partition wall portion 122, whereby the handle H is safely stored in the handle storage portion 1.

In the fishing reel stored in this way, since a knob Hn of the handle H and the star drag nut Nd are respectively placed on and supported by the first side surface sidewall portion 12 and the partition wall portion 122, the forward and backward movements of the fishing reel, as well as the left and right movements of the fishing reel, are prevented, thereby allowing the fishing reel to be stably fixed without using a separate packaging material, and thus storage and packaging may be achieved.

In this case, when a left-to-right width of the folding portion 131 or a left-to-right width of the first base portion 133 are adjusted, the fishing reel may be stored by pressing either a side cover of the fishing reel or an inner surface of the gearbox Fa against the partition wall portion 122, thereby maintaining the fishing reel in a more stable fixed state.

In addition, when the cover 16 is closed and fixed, the connecting portion 121 and the folding portion 131 are pressed by the cover 16, so the folding state of the partition wall portion 122 and the first inner wall portion 132 may be maintained more stably.

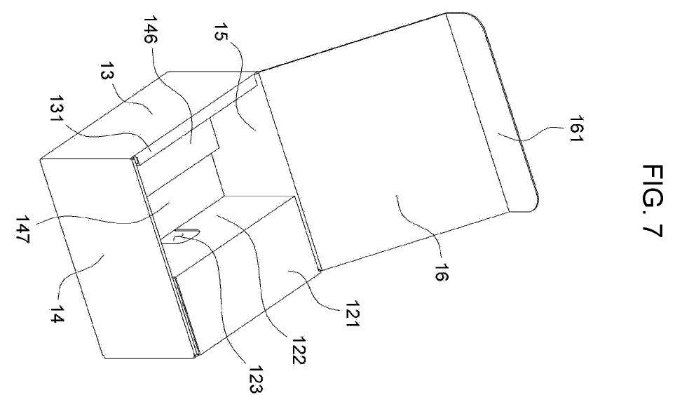

Next, a second exemplary embodiment of the present disclosure will be described with reference to FIGS. 7 to 10.

The second exemplary embodiment of the present disclosure is different from the first exemplary embodiment in that a base portion Sp is composed of a first base portion 146 and a second base portion 147, the first base portion 146 and the second base portion 147 are connected to a front sidewall portion 14, and a pressing portion 136 is connected to a second side surface sidewall portion 13 in place of a first inner wall portion 132. However, a partition wall portion 122 and a cover 16 are identical in configuration to those of the first exemplary embodiment.

Specifically, the second exemplary embodiment of the present disclosure includes: an inner wall portion 145 that are bent downward inward from the upper end of the front sidewall portion 14 and provided with stepped ends formed at different heights in a left and right direction to have different front-to-rear widths; an inner base portion 148 bent inward in a horizontal direction at one end having a front-to-rear width corresponding to a height of the front sidewall portion 14 among the stepped end portions of the inner wall portion 145, and adhered to the upper surface of a bottom portion 11; a second support portion 147 bent inward in a horizontal direction from a central portion of the stepped end portions of the inner wall portion 145, the central portion having a front-to-rear width shorter than that of the one end and being spaced upward from the bottom portion 11 so as to support a gearbox of a frame; a first base portion 146 bent inward in a horizontal direction from the other end, among the stepped end portions of the inner wall portion 145, the other end having a front-to-rear width shorter than that of the central portion and being spaced upward from the bottom portion 11 and arranged higher than the second base portion 147 so as to support a reel seat of the frame; a first support portion 146a bent downward from an inner end of the first base portion 146 and supported on the bottom portion 11; a second support portion 147a bent downward from an inner end of the second base portion 147 and supported on the bottom portion 11; a pressing portion 135 bent downward inward from a second side surface sidewall portion 13 and pressing the upper surface of the first base portion 146; and an anti-slip part 136 bent outward in a horizontal direction from a lower end of a pressing part 135 and supported by the second side surface sidewall portion 13.

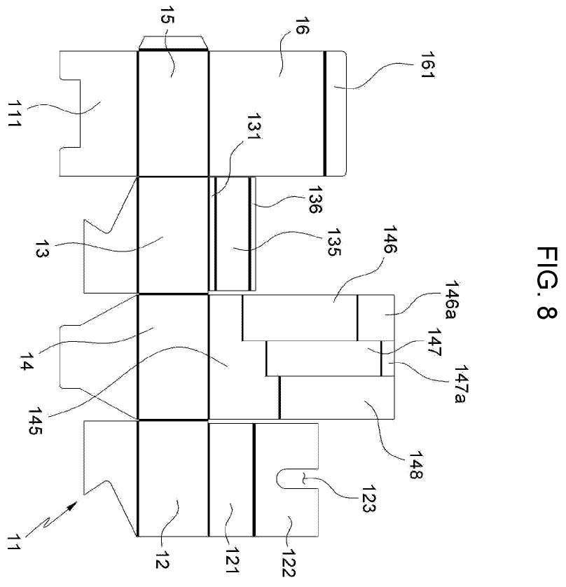

Referring to the unfolded view of FIG. 8, first, a folding portion 131 is foldably connected to the upper end of the second side surface sidewall portion 13, the pressing portion 135 is foldably connected to the upper end of the folding portion 131, and an anti-slip portion 136 is foldably connected to the upper end of the pressing portion 135.

In addition, the inner wall portion 145 is foldably connected to the upper end of the front sidewall portion 14, and an inner base 148 is foldably connected to one of the upper ends of the inner wall portion 145, so that the first base portion 146, the second base portion 147, and the inner base 148 have respective lengths in total corresponding to the front-to-rear width of the bottom portion 11. The second base portion 147 is foldably connected to a central portion of the upper ends of the inner wall portion 145, and the first base portion 146 is foldably connected to the other one of the upper ends of the inner wall portion 145. The first support portion 146a is foldably connected to the upper end of the first base portion 146, and the second support portion 147a is foldably connected to the upper end of the second base portion 147.

In this case, incisions are made along cutting lines between an area extending from the first base portion 146 to the first support portion 146a and an area extending from the second base portion 147 to the second base portion 147a, and between the area extending from the second base portion 147 to the second support portion 147a and an area of the anti-slip portion 136.

In this second exemplary embodiment, with the bottom portion 11 and sidewall portions 12, 13, 14, and 15, which are assembled in the box shape, the first support portion 146a and the second support portion 147a are respectively bent at a right angle with respect to the first base portion 146 and the second base portion 147, so as to face downward in the vertical direction. Thereafter, the inner wall portion 145 is bent downward toward the inner side of the front sidewall portion 14, and the first base portion 146 and the second base portion 147 are bent inward in the horizontal direction, whereby the first base portion 146 and the second base portion 147 are spaced upward from the bottom portion 11 by a predetermined distance due to the first support portion 146a and the second support portion 147a.

In this state, the folding portion 131 is bent horizontally toward the inner side of the second side surface sidewall portion 13, and then the pressing portion 135 is bent downward inward and the anti-slip portion 136 is bent outward in the horizontal direction, whereby the pressing portion 135 and the anti-slip portion 136 are allowed to press the first base portion 146.

In this assembled state, in a state in which a stud St, more precisely, a portion of a stud St between a tension nut Nt and a star drag nut Nd, is fitted into a fitting groove 123, the connecting portion 121 is bent inward in the horizontal direction, and then the partition wall portion 122 is bent upward to stand upright. When the bottom surface of a reel seat F1 and the bottom surface of a gearbox Fa are respectively placed on the first base portion 146 and the second base portion 147, the storage of a fishing reel is completed. At this time, the inner base 148 is laid on the bottom of a handle storage portion 1, whereby the fishing reel may be safely stored inside the packaging box as in the first exemplary embodiment.

Such a second exemplary embodiment may safely support not only the reel seat F1 but also the gearbox Fa having a height difference with the star drag nut Ns.

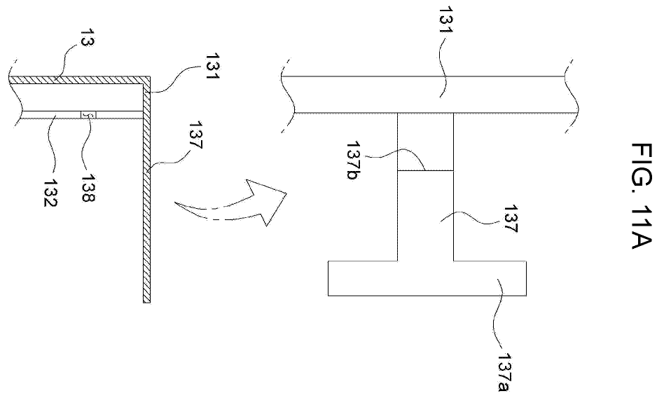

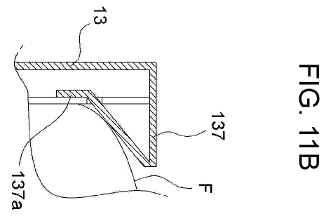

Meanwhile, as illustrated in FIGS. 11A and 11B, the first exemplary embodiment of the present disclosure includes: a pressing portion 137 in which a portion of an upper end of an inner surface of a first inner wall portion 132 is cut in an inverted “T” shape, this upper end is foldably connected to a folding portion 131, and a folding line 137b is formed on a central portion of the pressing portion 137; and a fitting portion 138 in which a portion of the first inner wall portion 132 is cut in a horizontal direction at both ends where the pressing portion 137 is cut.

Based on the folding line 137b, the pressing portion 137 is folded inwardly into an inverted right-angled triangle with respect to the first inner wall portion 132, and then a locking portion 137a protruding at both sides from the end of the pressing portion 137 is fitted into the fitting portion 138, so as to be fixed inside the first inner wall portion 132, thereby allowing a corner portion of the upper end of the frame F to be pressed by an inclined plane of the pressing portion 137.

The pressing portion 137 has the “T” shape and is a portion of the first inner wall portion 132 with the form of the locking portion 137a connected to the pressing portion 137.

The fitting portion 138 is cut at both cut surfaces of the pressing portion 137 with a width corresponding to the length of the locking portion 137a.

Accordingly, when the pressing portion 137 is folded into the inverted right-angled triangle shape and the locking portion 137a is fitted into the fitting portion 138, the pressing portion 137 is fixed in the inverted right-angled triangle shape. Accordingly, when the cover 16 is closed, the inclined plane of the pressing portion 137 may press and hold the upper corner of the frame F while the pressing portion 137 is pressed.

In the description of the present disclosure, the packaging box for the fishing reel has been described with reference to the accompanying drawings. However, the present disclosure may be variously modified, changed and substituted by those skilled in the art, and such modifications, changes and substitutions should be interpreted as falling within the protective scope of the present disclosure.

What is claimed is:

1. A packaging box for a fishing reel provided with a handle, a stud surrounding a shaft connected to the handle, and a frame having a spool mounted thereon, a gearbox provided on a stud side thereof, and a lower reel seat, the packaging box comprising:
a bottom portion and sidewall portions in a hexahedral form constituting a storage portion for the fishing reel; and
a cover for opening and closing a top opening of the packaging box,
wherein the packaging box comprises a first fixing member configured to be in close contact with an upper portion of the fishing reel when the reel seat is arranged downward, or a second fixing member configured to be in close contact with a lower portion of the fishing reel, or both the first and second fixing members.

2. The packaging box of claim 1, wherein the first fixing member comprises:
a partition wall portion provided with a fitting groove into which the stud is fitted.

3. The packaging box of claim 1, further comprising:
a base portion protruding at a predetermined height from the bottom portion and configured to support the frame.

4. The packaging box of claim 3, wherein the base portion comprises:
a first base portion configured to support the reel seat of the frame.

5. The packaging box of claim 4, wherein the base portion comprises:
a second base portion configured to support the frame.
